(19) United States
(12) Patent Application Publication
(10) Pub. No.: US 2009/0107330 A1
(43) Pub. Date: Apr. 30, 2009

(54) Amorphous silica hybrid membrane structure

(76) Inventor: Yunfeng Gu, Painted Post, NY (US)

Correspondence Address: CORNING INCORPORATED, SP-TI-3-1, CORNING, NY, 14831, US

(21) Appl. No.: 11/980,171

(22) Filed: Oct. 30, 2007

(51) Int. Cl. B01D 69/12; B01D 53/22; B01D 67/00; C04B 41/85; B01D 71/02

(52) U.S. Cl. 95/55; 210/490; 96/4; 210/500.25; 210/500.26; 427/245

(57) ABSTRACT

An amorphous silica hybrid membrane structure comprising a monolithic inorganic porous support, optionally one or more porous inorganic intermediate layers, and an amorphous silica membrane. The amorphous silica hybrid membrane is useful for gas separation applications, for example H₂ purification and CO₂ capture.

### FIELD OF THE INVENTION

The present invention relates to amorphous silica hybrid membrane structures useful for molecular level gas separations and methods for making the same.

### BACKGROUND OF THE INVENTION

There are a number of industrial processes, such as coal gasification, biomass gasification, steam reforming of hydrocarbons, partial oxidation of natural gas, etc., which produce gas streams that include CO₂, H₂ and CO. It is frequently desirable to remove CO₂ from those gas mixtures to capture CO₂, for example for sequestration purposes and to produce H₂ or H₂-enriched gas product.

Membranes made of polymeric materials have been developed and commercially used for molecular separation, such as separating CO₂ from natural gas streams. However, polymeric membranes are associated with poor thermal and chemical stability, and their permeation flux is often low. Moreover, hydrocarbons ubiquitously exist in CO₂ gas mixtures derived from fossil fuel sources, and these hydrocarbons can cause degradation of the polymeric membranes by dissolution, fouling, etc., further limiting widespread use of polymeric membranes.

Inorganic membranes are an emerging technology area and hold high promise to overcome the thermal and chemical stability issues that are associated with polymeric membrane materials. CO₂ separation functions of inorganic membranes, however, have not been well demonstrated yet, perhaps because making a defect-free inorganic membrane in a practical way remains a large material processing challenge. In addition, conventional inorganic membranes frequently offer much lower surface area packing density than do polymeric membranes because of the inorganic membrane's tubular or planar disk forms, as illustrated in FIGS. 1A and 1B. In FIGS. 1A and 1B, arrow 102 represents a gas mixture that is to be separated; arrow 104 represents a permeate stream; and arrow 106 represents a retentate stream.

Conventional inorganic membrane technology can also impose a large manufacturing and engineering cost based on the unit-membrane-separation-area, further limiting widespread application of zeolite and other inorganic membranes.

In view of the forgoing, there is a need for materials and methods that can be used for molecular level gas separations, and the present invention is directed, at least in part, to addressing this need.

### SUMMARY OF THE INVENTION

The present invention relates to a hybrid membrane structure comprising:
a monolithic inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
an amorphous silica membrane; wherein, when the hybrid membrane structure does not comprise the one or more porous inorganic intermediate layers, the amorphous silica membrane coats the inner channel surfaces of the inorganic porous support; and wherein, when the hybrid membrane structure comprises the one or more porous inorganic intermediate layers, the amorphous silica membrane coats the surface of the one or more porous intermediate layers.

The present invention also relates to a method for making a hybrid membrane structure, which comprises:
providing a monolithic inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support; and
applying an amorphous silica membrane; wherein, when the one or more porous inorganic intermediate layers have not been applied to the inorganic porous support's inner channel surfaces, the amorphous silica membrane is applied to the inner channel surfaces of the inorganic porous support; and wherein, when the one or more porous inorganic intermediate layers have been applied to the inorganic porous support's inner channel surfaces, the amorphous silica membrane is applied to the surface of the one or more porous intermediate layers.

The hybrid membrane structure could be used to solve significant energy and environmental problems, such as H₂ recovery from waste gas streams, H₂ purification from a production gas mixture for fuel cells application, and H₂ purification and CO₂ capture in the coal gasification process for sequestration.

These and additional features and embodiments of the present invention will be more fully illustrated and discussed in the following drawings and detailed description.

### BRIEF DESCRIPTION OF THE DRAWINGS

FIGS. 1A and 1B are schematic representations of conventional inorganic gas separation membrane designs and the flow of gases therein. FIG. 1A shows a perspective view of a tubular membrane. FIG. 1B shows a cross-sectional view of a planar disk membrane.

FIG. 2 is a representation of a hybrid membrane structure according to one embodiment the present invention.

FIGS. 3A and 3B are longitudinal cross-sectional representations of hybrid membrane structures according to the present invention taken through plane A of FIG. 2.

FIG. 4 is a schematic of a chemical vapor deposition apparatus for applying an amorphous silica membrane according to an embodiment of the present invention.

FIG. 5 is a schematic of a chemical vapor deposition assembly according to an embodiment of the present invention.

FIG. 6 is a schematic representation of a hybrid membrane structure according to the present invention showing its use in a gas separation application.

FIGS. 7A and 7B are SEM images of the channels surfaces (7A) and cross-sectional view (7B) of a gamma-alumina intermediate layer according to an embodiment of the invention.

FIGS. 8A and 8B are SEM images of the cross-section (8A) and top surface (8B) views of an amorphous silica membrane according to an embodiment of the invention.

FIGS. 9A, 9B and 9C are SEM images of the cross-section view of an amorphous silica membrane deposited on different positions (end, middle and beginning, respectively) along the axial direction of a monolithic support 9D according to the carrier gas flow direction.

FIG. 10 is a graph comparing the change of ideal selectivity of amorphous silica membranes with deposition time by pressurized chemical vapor deposition and non-pressurized chemical vapor deposition.

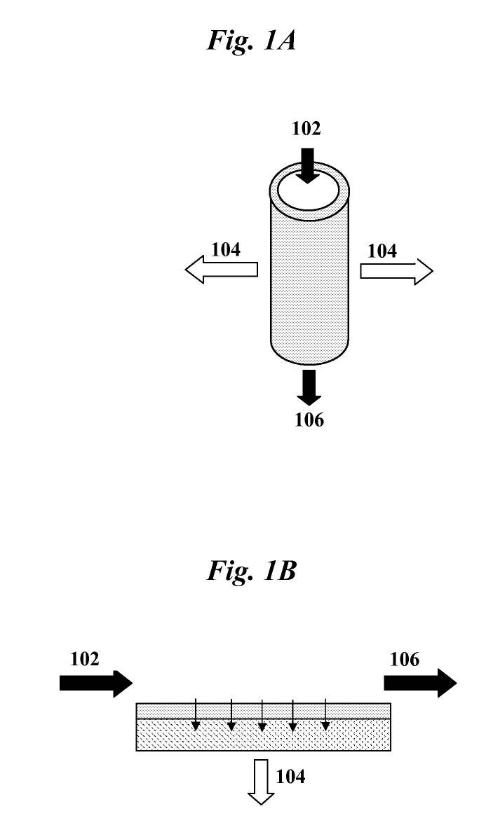

The embodiments set forth in the figures are illustrative in nature and not intended to be limiting of the invention defined by the claims. Individual features of the drawings and the invention will be more fully discussed in the following detailed description.

### DETAILED DESCRIPTION OF THE INVENTION

One aspect of the present invention relates to a hybrid membrane structure that comprises:
a monolithic inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
an amorphous silica membrane; wherein, when the hybrid membrane structure does not comprise the one or more porous inorganic intermediate layers, the amorphous silica membrane coats the inner channel surfaces of the inorganic porous support; and wherein, when the hybrid membrane structure comprises the one or more porous inorganic intermediate layers, the amorphous silica membrane coats the surface of the one or more porous intermediate layers.

Suitable inorganic porous support materials include ceramics, glass ceramics, glasses, carbon, metals, clays, and combinations thereof. Examples of these and other materials from which the inorganic porous support can be made or which can be included in the inorganic porous support are, illustratively: metal oxide, alumina (e.g., alpha-aluminas, delta-aluminas, gamma-aluminas, or combinations thereof), cordierite, mullite, aluminum titanate, titania, zeolite, metal (e.g., stainless steel), ceria, magnesia, talc, zirconia, zircon, zirconates, zirconia-spinel, spinel, silicates, borides, alumino-silicates, porcelain, lithium alumino-silicates, feldspar, magnesium alumino-silicates, fused silica, carbides, nitrides, silicon carbides, and silicon nitrides.

In certain embodiments, the inorganic porous support is primarily made from or otherwise comprises alumina (e.g., alpha-alumina, delta-alumina, gamma-alumina, or combinations thereof), cordierite, mullite, aluminum titanate, titania, zirconia, zeolite, metal (e.g., stainless steel), silica carbide, ceria, or combinations thereof.

In one embodiment, the inorganic porous support is a glass. In another embodiment, the inorganic porous support is a glass-ceramic. In another embodiment, the inorganic porous support is a ceramic. In another embodiment, the inorganic porous support is a metal. In yet another embodiment, the inorganic porous support is carbon, for example a carbon support derived by carbonizing a resin, for example, by carbonizing a cured resin.

In certain embodiments, the inorganic porous support is in the form of a honeycomb monolith. Honeycomb monoliths can be manufactured, for example, by extruding a mixed batch material through a die to form a green body, and sintering the green body with the application of heat utilizing methods known in the art. In certain embodiments, the inorganic porous support is in the form of ceramic monolith. In certain embodiments, the monolith, for example a ceramic monolith, comprises a plurality of parallel inner channels.

The inorganic porous support can have a high surface area packing density, such as a surface area packing density of greater than 500 m²/m³, greater than 750 m²/m³, and/or greater than 1000 m²/m³.

As noted above, the monolithic inorganic porous support includes a plurality of inner channels having surfaces defined by porous walls. The number, spacing, and arrangement of the inner channels can be selected in view of the potential application of the hybrid membrane structure. For example the number of channels can range from 2 to 1000 or more, such as from 5 to 500, from 5 to 50, from 5 to 40, from 5 to 30, from 10 to 50, from 10 to 40, from 10 to 30, etc; and these channels can be of substantially the same cross sectional shape (e.g., circular, oval, square, hexagonal, etc.) or not. The channels can be substantially uniformly dispersed in the inorganic porous support's cross section or not (e.g., as in the case where the channels are arranged such that they are closer to the outer edge of the inorganic porous support than to the center). The channels can also be arranged in a pattern (e.g., rows and columns, offset rows and columns, in concentric circles about the inorganic porous support's center, etc.).

In certain embodiments, the inner channels of the inorganic porous support have a hydraulic inside diameter of from 0.5 millimeters to 3 millimeters, such as in cases where the inner channels of the inorganic porous support have a hydraulic inside diameter of 1±0.5 millimeter, 2±0.5 millimeter, from 2.5 millimeters to 3 millimeters, and/or from 0.8 millimeters to 1.5 millimeters. In certain embodiments, the inner channels of the inorganic porous support have a hydraulic inside diameter of 3 millimeters or less, for example less than 3 millimeters. For clarity, note that “diameter” as used in this context is meant to refer to the inner channel's cross sectional dimension and, in the case where the inner channel's cross section is non-circular, is meant to refer to the diameter of a hypothetical circle having the same cross sectional area as that of the non-circular inner channel.

In certain embodiments, the porous walls which define the inner channels' surfaces have a median pore size of 25 microns or less. In certain embodiments, the porous walls which define the inner channels' surfaces have a median pore size of from 5 nanometers to 25 microns, such as in cases where the porous walls which define the inner channels' surfaces have a median pore size of 10±5 nanometers, 20±5 nanometers, 30±5 nanometers, 40±5 nanometers, 50±5 nanometers, 60±5 nanometers, 70±5 nanometers, 80±5 nanometers, 90±5 nanometers, 100±5 nanometers, 100±50 nanometers, 200±50 nanometers, 300±50 nanometers, 400±50 nanometers, 500±50 nanometers, 600±50 nanometers, 700±50 nanometers, 800±50 nanometers, 900±50 nanometers, 1000±50 nanometers, 1±0.5 microns, and/or 2±0.5 microns. In other embodiments, the inner channel surfaces have a median pore size from 5 microns to 15 microns.

In certain embodiments, the porous walls which define the inner channels' surfaces have a median pore size of 1 micron or less. In certain embodiments, the porous walls which define the inner channels' surfaces have a median pore size of 500 nanometers or less, such as in cases where the porous walls which define the inner channels' surfaces have a median pore size of from 5 nanometers to 500 nanometers, from 5 nanometers to 400 nanometers, from 5 nanometers to 300 nanometers, from 5 nanometers to 400 nanometers, from 5 nanometers to 300 nanometers, from 5 nanometers to 400 nanometers, from 5 nanometers to 200 nanometers, from 5 nanometers to 100 nanometers, from 5 nanometers to 50 nanometers, etc. For clarity, note that “size” as used in this context is meant to refer to a pore's cross sectional diameter and, in the case where the pore's cross section is non-circular, is meant to refer to the diameter of a hypothetical circle having the same cross sectional area as that of the non-circular pore.

In certain embodiments, the inorganic porous support has a porosity of from 20 percent to 80 percent, such as a porosity of from 30 percent to 60 percent, from 50 percent to 60 percent, or from 35 percent to 50 percent. When a metal, such as stainless steel, is used as the inorganic porous support, porosity in the stainless steel support can be effected, for example, using engineered pores or channels made by three-dimensional printing, by high energy particle tunneling, and/or by particle sintering using a pore former to adjust the porosity and pore size.

To allow for more intimate contact between a fluid stream flowing through the support and the coated support itself, for example when used in a separation application, it is desired in certain embodiments that at least some of the channels are plugged at one end of the support, while other channels are plugged at the other end of the support. In certain embodiments, it is desired that at each end of the support, the plugged and/or unplugged channels form a checkerboard pattern with each other. In certain embodiments, it is desired that where one channel is plugged on one end (referred to as “the reference end”) but not the opposite end of the support, at least some, for example a majority, of the channels (preferably all of the channels in certain other embodiments) immediately proximate thereto (those sharing at least one wall with the channel of concern) are plugged at such opposite end of the support but not on the reference end.

It will be appreciated that individual inorganic porous supports can be stacked or housed in various manners to form larger inorganic porous supports having various sizes, service durations, and the like to meet the needs of differing use conditions.

As noted above, the hybrid membrane structure can optionally comprise one or more porous inorganic intermediate layers coating the inner channel surfaces of the inorganic porous support. In certain embodiments, the hybrid membrane structure does not comprise the one or more porous inorganic intermediate layers. In this instance, the amorphous silica membrane coats the inner channel surfaces of the inorganic porous support. In one embodiment of this aspect of the invention, the inorganic porous support comprises a median pore size of 1 micron or less.

In other embodiments, the hybrid membrane structure does include the one or more porous inorganic intermediate layers. In this instance, the amorphous silica coats the surface of the one or more porous intermediate layers. In one embodiment of this aspect of the invention, the inorganic porous support comprises a median pore size of 5 microns to 15 microns.

In those cases where the hybrid membrane structure does comprise the one or more porous inorganic intermediate layers, and the amorphous silica membrane coats the surface of the one or more porous intermediate layers, it will be appreciated that the “surface of the one or more porous intermediate layers” refers to the outer surface of the intermediate layer (i.e., the surface that is exposed to the channel) or, in the case where there is more than one porous intermediate layer, to the outer surface of the outermost intermediate layer (i.e., the intermediate layer most distant from the inner channel surfaces of the inorganic porous support). In particular, the phrase “the amorphous silica membrane coats the surface of the one or more porous intermediate layers” is not meant to be construed as requiring that the amorphous silica membrane coat every porous intermediate layer or every side of every porous intermediate layer.

Whether or not to employ the one or more porous inorganic intermediate layers can depend on a variety of factors, such as the nature of the inorganic porous support; the median diameter of the inorganic porous support's inner channels; the use to which the hybrid membrane structure is to be put and the conditions (e.g., gas flow rates, gas pressures, etc.) under which it will be employed; the roughness or smoothness of the inner channels' surfaces; the median pore size of the porous walls which define the inner channels' surfaces; and the like.

By way of illustration, in certain embodiments, the porous walls of the inorganic porous support comprise a median pore size that is sufficiently small so that, when the amorphous silica membrane is coated directly on the inner channels' surfaces, the resulting coating is smooth and thin. Examples of median pore sizes that are thought to be sufficiently small so as not to significantly benefit (in terms of smoothness of the amorphous silica membrane coating) from the use of the porous inorganic intermediate layer(s) (for at least some applications) are those that are less than about 100 nanometers. Even less benefit is attained when the median pore size is less than about 80 nanometers; still less benefit is attained when the median pore size is less than about 50 nanometers (e.g., in the 5 nanometer to 50 nanometer range).

By way of further illustration, in certain embodiments, the porous walls of the inorganic porous support comprise a median pore size that is sufficiently large so that, when the amorphous silica membrane is coated directly on the inner channels' surfaces, the resulting coating may be rough. In such cases, it may be advantageous to use the porous inorganic intermediate layer(s). Examples of median pore sizes that are thought to be sufficiently large so as to significantly benefit (in terms of smoothness of the amorphous silica membrane coating) from the use of the porous inorganic intermediate layer(s) (for at least some applications) are those that are more than about 100 nanometers. Even greater benefit is attained when the median pore size is more than about 200 nanometers; still greater benefit is attained when the median pore size is more than about 300 nanometers (e.g., in the 300 nanometer to 50 micron range).

Illustratively, in certain embodiments, the porous walls of the inorganic porous support have a median pore size of from 5 nanometers to 100 nanometers (e.g., from 5 nanometers to 50 nanometers), the hybrid membrane structure does not include the one or more porous inorganic intermediate layers, and the amorphous silica membrane coats the inner channel surfaces of the inorganic porous support. In other embodiments, the porous walls of the inorganic porous support have a median pore size of from 50 nanometers to 25 microns (e.g., from 100 nanometers to 15 microns or from 5 microns to 15 microns), the hybrid membrane structure comprises the one or more porous inorganic intermediate layers, and the amorphous silica membrane coats the surface of the one or more porous intermediate layers.

As noted above, the one or more porous inorganic intermediate layers can be used to increase the smoothness of the surface onto which the amorphous silica membrane is coated, for example, to improve flow of a gas that may pass through the channels; to improve uniformity of the amorphous silica membrane coating; to decrease the number and/or size of any gaps, pinholes, or other breaks in the amorphous silica membrane coating; to decrease the thickness of the amorphous silica membrane coating needed to achieve a amorphous silica membrane coating having an acceptably complete coverage (e.g. no or an acceptably small number of gaps, pinholes, or other breaks). Additionally or alternatively, the one or more porous inorganic intermediate layers can be used to decrease the effective diameter of the inorganic porous support's inner channels. Still additionally or alternatively, the one or more porous inorganic intermediate layers can be used to alter the chemical, physical, or other properties of the surface onto which the amorphous silica membrane is coated.

Examples of materials from which the one or more porous inorganic intermediate layers can be made include metal oxides, ceramics, glasses, glass ceramics, carbon, and combinations thereof. Other examples of materials from which the one or more porous inorganic intermediate layers can be made include cordierite, mullite, aluminum titanate, zeolite, silica carbide, and ceria. In certain embodiments, the one or more porous inorganic intermediate layers are made from or otherwise include alumina (e.g., alpha-alumina, delta-alumina, gamma-alumina, or combinations thereof), titania, zirconia, silica, or combinations thereof.

In certain embodiments, the median pore size of each of the one or more porous inorganic intermediate layers is smaller than the median pore size of the inorganic porous support's porous walls. By way of illustration, the one or more porous intermediate layers can comprise a median pore size of from 5 nanometers to 100 nanometers, such as from 5 nanometers to 50 nanometers, from 5 nanometers to 40 nanometers, from 5 nanometers to 30 nanometers, 10±5 nanometers, 20±5 nanometers, 30±5 nanometers, 40±5 nanometers, 50±5 nanometers, 60±5 nanometers, 70±5 nanometers, 80±5 nanometers, and/or 90±5 nanometers. Where two or more porous intermediate layers are present, each of the two or more porous intermediate layers can have the same median pore size or some or all of them can have different median pore sizes.

In certain embodiments, the hybrid membrane structure includes two or more porous intermediate layers, and the median pore size of the porous intermediate layer which contacts the inorganic porous support is greater than the median pore size of the porous intermediate layer which contacts the amorphous silica membrane. Illustratively, in cases where the inorganic porous support has a median pore size larger than 300 mm (e.g., larger than 500 mm, larger than 1 micron, larger than 2 microns, larger than 3 microns, etc.) the hybrid membrane structure can include two porous intermediate layers: the first layer (i.e., the one that is in contact with the inorganic porous support) having a median pore size that is smaller than the inorganic porous support's median pore size (e.g., having a median pore size of from 20 nm to 200 nm, for example from 100 nm to 200 nm) and the second intermediate layer (i.e., the one that is in contact with the amorphous silica membrane) having a median pore size that is smaller than the first intermediate layer's median pore size (e.g., having a median pore size of from 5 nm to 50 nm). Such arrangements can be used to provide a smooth surface onto which the amorphous silica membrane is coated without unacceptably decreasing permeability from the inner channels, through the pores of the first intermediate layer, through the larger pores of the second intermediate layer, through the still larger pores of the inorganic porous support, and to the outside of the inorganic porous support.

The hybrid membrane structure may also comprise, for example, three or more intermediate layers. As above, the invention includes an embodiment wherein the median pore sizes of the intermediate layers decreases with each addition of an intermediate layer in the direction of the amorphous silica membrane.

In those cases where the hybrid membrane structure comprises the one or more porous intermediate layers, the one or more porous intermediate layers can have a combined thickness of, for example, from 1 micron to 100 microns, such as from 20 nanometers to 100 microns, such as from 2 microns to 80 microns, from 5 microns to 60 microns, 10 microns to 50 microns, etc.

It will be appreciated that not all the channels need be coated with the one or more intermediate layers. For example, the intermediate layers can coat all of the inner channel surfaces of the inorganic porous support; or the intermediate layers can coat some of the inner channel surfaces of the inorganic porous support; and the phrase “the intermediate layer coats the inner channel surfaces of the inorganic porous support” is meant to encompass both situations.

As noted above, irrespective of whether or not the hybrid membrane structure includes the one or more porous intermediate layers, the hybrid membrane structure also includes an amorphous silica membrane. In those cases where the hybrid membrane structure does not include the one or more porous inorganic intermediate layers, the amorphous silica membrane coats the inner channel surfaces of the inorganic porous support. In those cases where the hybrid membrane structure does include the one or more porous inorganic intermediate layers, the amorphous silica membrane coats the surface of the one or more porous intermediate layers.

It will be appreciated that not all the channels need be coated with the amorphous silica membrane. For example, the amorphous silica membrane can coat all of the inner channel surfaces of the inorganic porous support; or the amorphous silica can coat some of the inner channel surfaces of the inorganic porous support; and the phrase “the amorphous silica membrane coats the inner channel surfaces of the inorganic porous support” is meant to encompass both situations. Likewise, in those cases where the porous intermediate layer(s) is employed, the amorphous silica membrane can coat the surface of the one or more porous intermediate layers in every channel; or the amorphous silica membrane can coat the surface of the one or more porous intermediate layers in some of the channels; and the phrase “the amorphous silica membrane coats the surface of the one or more porous intermediate layers” is meant to encompass both situations.

The amorphous silica membrane may comprise additives. For example, the amorphous silica membrane may comprise an organic additive, an inorganic additive, or both. Such additives may be present, for example, in an amount of up to 20 weight % by weight of the amorphous silica membrane, for example. Organic additives include compounds having organic groups, such as amines, with strong affinity for CO₂, for example. Inorganic additives include compounds that can improve the hydrothermal stability of the membrane, such as alumina and titania.

The amorphous silica membrane may also comprise silica bound to organic functional groups, such as amines, in addition to, or as an alternative to, the presence of separate additives in the membrane. Thus, the term “amorphous silica membrane” includes membranes comprising amorphous silica modified by functional groups such as those described above. In some embodiments, up to 10 weight % of the silica is modified with such functional groups.

In certain embodiments, the amorphous silica membrane has a thickness of from 20 nanometers to 2 microns, for example from 20 nanometers to 1 micron, for example from 20 nanometers to 200 nanometers, for example from 20 nanometers to 50 nanometers. In other embodiments, the amorphous silica membrane has a thickness of from 20 nanometers to 50 nanometers. In certain embodiments, the thickness of the membrane is substantially uniform.

For certain applications, it may be desirable that the amorphous silica membrane coats the entire surface of the porous intermediate layer(s) or the entire inner channel surfaces of the inorganic porous support. As further illustration, for certain applications, it may be desirable that the number and/or size of any gaps, pinholes, or other breaks in the amorphous silica membrane coating be small in size and few in number (e.g., as in the case where there are no gaps, pinholes, or other breaks in the amorphous silica membrane coating or as in the case where the collective area of any gaps, pinholes, or other breaks in the amorphous silica membrane coating is less than 1% (such as less than 0.5%, 0.1%, 0.01%, etc.) of the total surface area coated by the amorphous silica membrane coating.

Certain embodiments of the present invention can have advantages over prior art polymer membranes and prior art inorganic membranes, for example, in terms of durability and/or strength; in terms of regeneration or refurbishment; and/or in terms of permeation flux (for structures to be used in gas separation applications).

By way of illustration, in certain embodiments of the hybrid membrane structures of the present invention, the inorganic porous support structure can provide a backbone for surface area, mechanical strength, and durability, while providing surface area packing density comparable to the pure polymeric membranes.

Still additionally or alternatively, in certain embodiments of the hybrid membrane structures of the present invention, the inorganic porous support can have a substantially uniform pore structure on the inorganic porous support channel surfaces (or substantially uniform pore structure can be generated by the use of the optional one or more porous inorganic intermediate layers). This can enable deposition of a thin and durable amorphous silica membrane layer; and the thin amorphous silica membrane layer can offer high permeation flux. The hybrid membrane structures can thus provide a large potential advantage in manufacturing cost relative to the cost of manufacturing prior art inorganic membranes.

Monolithic amorphous silica membrane products of small channel sizes also offer surface area packing density nearly one order of magnitude higher than conventional tubular membrane of comparable body diameter. This can lead to dramatic reduction of both the membrane cost per surface area and the engineering costs to assembly large surface areas of membrane modules. Disk-shaped membrane products, on the other hand, are not practical for large-scale application.

Multiple-layered membrane structures enable use of support structures of large pores (that is, high permeability through the bare support) and enable deposition of thin silica membrane layer (that is, high membrane permeation flux). As a result of enhancement to both support and membrane permeability, the present membrane-layer design enables achievement of high membrane permeation flux.

It will be appreciated that all, some, or none of the advantages discussed above may or may not be achieved in a particular hybrid membrane structure of the present invention. For example, a particular hybrid membrane structure of the present invention may be designed with other considerations in mind, and these other considerations may reduce or negate some or all of the above-discussed advantages or other advantages. The advantages discussed above are not meant to be limiting, and they are not to be construed, in any way, as limiting the scope of the invention.

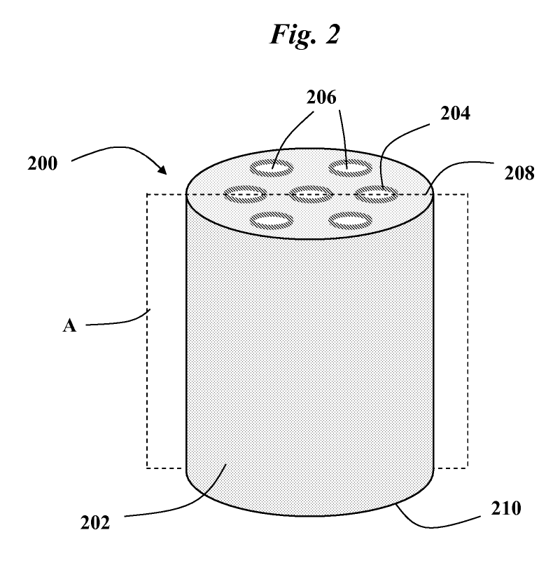

FIG. 2 is a perspective view of a hybrid membrane structure 200 according to one embodiment of the invention. In this embodiment, hybrid membrane structure 200 includes inorganic porous support 202 and amorphous silica membrane 204 either with or without one or more intermediate layers. Inorganic porous support 202 is shown as including first end 208, second end 210, and plurality of inner channels 206 that extend through inorganic porous support 202 from first end 208 to second end 210.

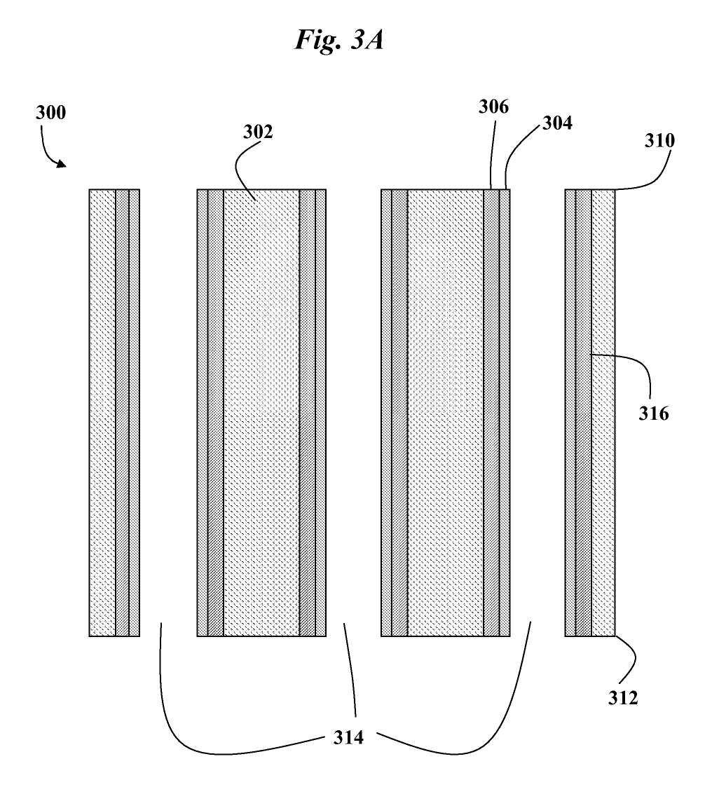

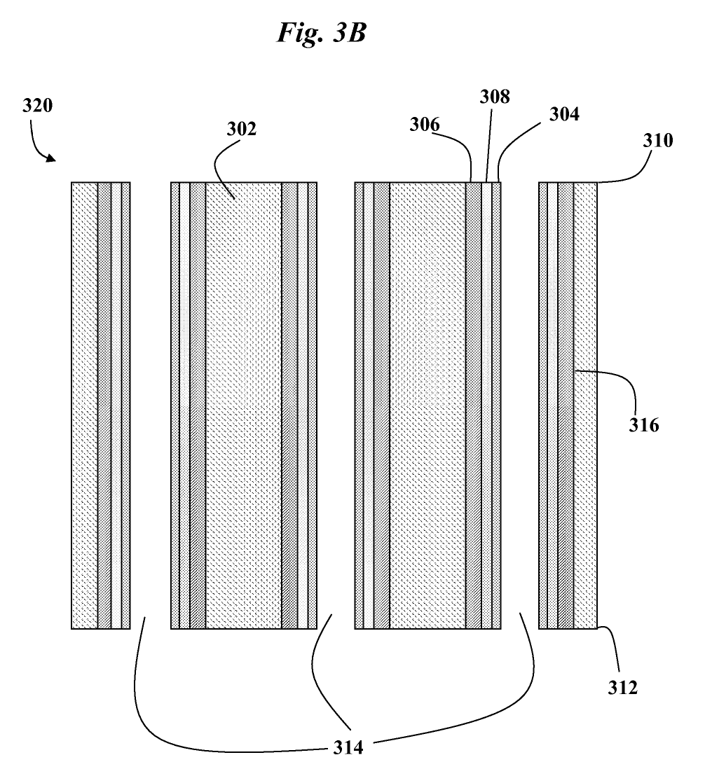

FIGS. 3A and 3B are a longitudinal cross-sectional views of the hybrid membrane structure shown in FIG. 2 taken through plane A of FIG. 2. FIG. 3A illustrates an embodiment comprising one intermediate layer, while FIG. 3B illustrates an embodiment comprising two intermediate layers.

In these embodiments, hybrid membrane structures 300 and 320 include inorganic porous support 302, amorphous silica membrane 304, and a first porous inorganic intermediate layer 306. The embodiment illustrated in FIG. 3B further includes a second inorganic intermediate layer 308. Inorganic porous support 302 is shown as including first end 310, second end 312, and plurality of inner channels 314 that extend through inorganic porous support 302 from first end 310 to second end 312. Inner channels 314 of the support have surfaces 316 defined by porous walls, and first porous inorganic intermediate layer 306 coats surfaces 316 of inner channels 314. Amorphous silica membrane 304 coats the first (FIG. 3A) or second (FIG. 3B) intermediate layer.

The hybrid membrane structures of the present invention can be prepared by a variety of procedures, such as, for example, by the methods discussed below.

The present invention also relates to a method for making a hybrid membrane structure. The method comprises:
providing a monolithic inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support; and
applying an amorphous silica membrane; wherein, when the one or more porous inorganic intermediate layers have not been applied to the inorganic porous support's inner channel surfaces, the amorphous silica membrane is applied to the inner channel surfaces of the inorganic porous support; and wherein, when the one or more porous inorganic intermediate layers have been applied to the inorganic porous support's inner channel surfaces, the amorphous silica membrane is applied to the surface of the one or more porous intermediate layers.

Suitable inorganic porous supports that can be used in the practice of the method of the present invention include those discussed hereinabove.

The inorganic porous support can be provided in a variety of different ways. For example, it can be obtained commercially. Alternatively, it can be prepared by methods that are well known to those skilled in the art.

Illustratively, suitable inorganic porous supports can be prepared in accordance with the methods described in co-pending U.S. Patent Application No. 60/874,070, filed Dec. 11, 2006, which is hereby incorporated by reference; in U.S. Pat. No. 3,885,977 to Lachman et al., which is hereby incorporated by reference; and in U.S. Pat. No. 3,790,654 to Bagley et al., which is hereby incorporated by reference.

For example, the inorganic porous support can be made by combining 60 wt % to 70 wt % of alpha-alumina (having a particle size in the range of 5 microns to 30 microns), 30 wt % of an organic pore former (having a particle size in the range of 7 microns to 45 microns), 10 wt % of a sintering aid, and other batch components (e.g., crosslinker, etc.). The combined ingredients are mixed and allowed to soak for a period of time (e.g., 8 to 16 hours). The mixture is then shaped into a green body by extrusion. The resulting green body is sintered (e.g., at a temperature of 1500° C. or greater for a suitable period of time, such as for 8 to 16 hours) to form an inorganic porous support.

As noted above, the method of the present invention can optionally include applying one or more porous inorganic intermediate layers to the inner channel surfaces of the inorganic porous support. Situations in which one might wish to use the optional porous inorganic intermediate layer(s) and suitable materials from which the porous inorganic intermediate layer(s) can be made include those that are discussed hereinabove.

In those situations in which the method of the present invention includes applying one or more porous inorganic intermediate layers to the inner channel surfaces of the inorganic porous support, the one or more porous inorganic intermediate layers can be applied to the inner channel surfaces using any suitable method. Illustratively, the porous inorganic intermediate layers can be applied by coating (e.g., flow coating in a suitable liquid) ceramic or other inorganic particles of appropriate size (e.g., on the order of tens of nanometers to hundreds of nanometers) onto the inner channel surfaces of the inorganic porous support. The inorganic porous support coated with the ceramic or other inorganic particles is then dried and fired to sinter the ceramic or other inorganic particles, thus forming a porous inorganic intermediate layer. Additional porous inorganic intermediate layers can be applied to the coated inorganic porous support by repeating the above process (e.g., with different inorganic particles), typically with drying and firing after each layer's application.

The drying and firing schedules can be adjusted based on the materials used in the inorganic porous support and in the porous inorganic intermediate layer(s). For example, an alpha-alumina intermediate layer applied to an alpha-alumina porous support can be dried in a humidity controlled environment while maintaining a suitable temperature (e.g., 120° C.) for a suitable period of time (e.g., 20 hours); and, once dried, the alpha-alumina intermediate layer can be fired under conditions effective to remove organic components and to sinter the intermediate layer's alpha-alumina particles, such as, for example, at a temperature of from 900° C. to 1200° C. under a controlled gas environment.

Suitable methods for coating ceramic or other inorganic particles onto the inner channel surfaces of inorganic porous support and for forming them into porous inorganic intermediate layers are described, for example, in U.S. patent application Ser. No. 11/729,732, filed Mar. 29, 2007, which is hereby incorporated by reference; in U.S. patent application Ser. No. 11/880,066, filed Jul. 19, 2007, which is hereby incorporated by reference; and in U.S. patent application Ser. No. 11/880,073, filed Jul. 19, 2007, which is hereby incorporated by reference.

A porous inorganic intermediate layer comprising gamma-alumina may also be applied with use of a stable colloidal boehmite (AlOOH) sol. For example, such a layer can be a second or subsequent intermediate layer that is coated on another intermediate layer, such as on an alpha-alumina intermediate layer. For instance, such a layer comprising gamma-alumina can be coated on another intermediate layer such as alpha-alumina that has a median pore size of 20 nanometers to 1 micron, for example from 100 nanometers to 200 nanometers. The applied gamma-alumina intermediate layer may comprise, as an example a median pore size of 5 nanometers or more.

A sol-gel process can be used to apply an intermediate layer of gamma-alumina. Firstly, a boehmite (AlOOH) sol can be made by hydrolysis of alumina alkoxide (aluminum tri-sec-butoxide, aluminum isopropoxide, etc.) and subsequent peptization with an acid (nitric acid, hydrochloride acid or acetic acid). Secondly, a coating solution can be made by mixing the boehmite sol with polymer binder solution and D.I. water. PVA (polyvinyl alcohol) and PEG (polyethylene glycol) are example polymer binders. The PVA and sol concentrations can be, for example, 0.3 to 1.3 wt. % and 0.2-0.6 mol/l, respectively. Then, a flow-coating method can be used to place a gamma-alumina coating on the inner channel surface of the support or of other intermediate layers. The coated support can then be dried and fired at 600-800° C., for example at 650° C. The same coating-drying-firing process can be repeated, for instance with the use of more dilute coating solution.

Irrespective of whether or not the method of the present invention includes the optional step of applying one or more porous inorganic intermediate layers to the inner channel surfaces of the inorganic porous support, the method also involves the application of an amorphous silica membrane. In those cases where one or more porous inorganic intermediate layers have not been applied to the inorganic porous support's inner channel surfaces, the amorphous silica membrane is applied to the inner channel surfaces of the inorganic porous support. In those cases where the one or more porous inorganic intermediate layers have been applied to the inorganic porous support's inner channel surfaces, the amorphous silica membrane is applied to the surface of the one or more porous intermediate layers.

Application of the amorphous silica membrane (i.e., to the inner channel surfaces of the inorganic porous support or to the surface of the one or more porous intermediate layers) can be carried out by any suitable process.

Illustratively, the amorphous silica membrane can be applied onto the inner channel surfaces of the inorganic porous support or onto the surface of the one or more porous intermediate layers by chemical vapor deposition (CVD).

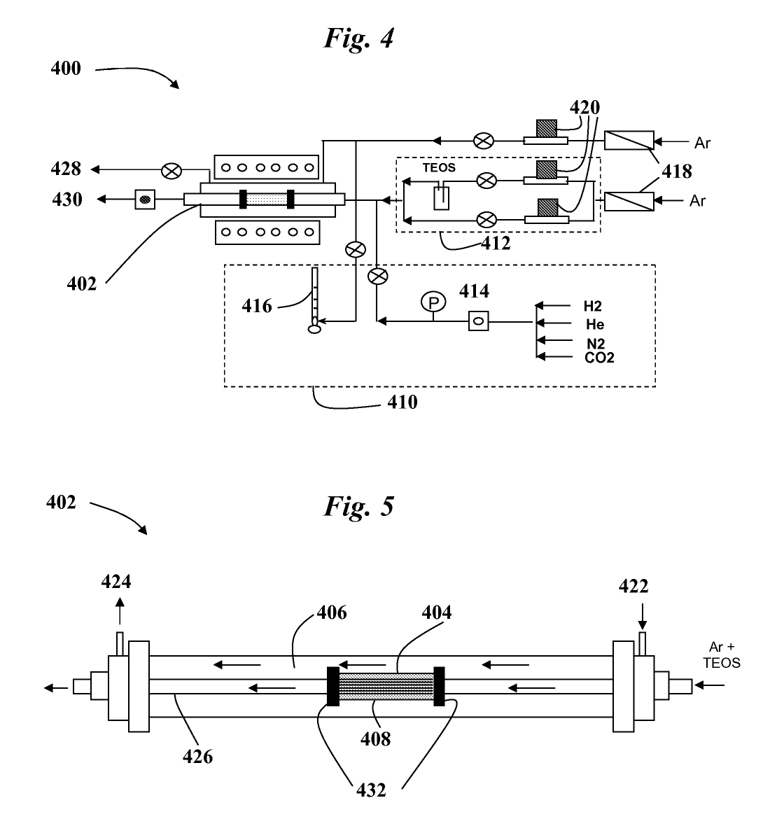

A CVD apparatus 400 illustrated in FIG. 4, for example, can be used to apply an amorphous silica layer on the inorganic support (modified or not with one or more intermediate layers, such as modified with a gamma-alumina intermediate layer) via thermal decomposition of tetraethoxysilane (TEOS) or tetramethoxysilane (TMOS) at high temperature in the absence of oxygen and water. The CVD apparatus includes a CVD reactor assembly 402, which is shown in greater detail in FIG. 5. The support 408 can be placed into a CVD reactor assembly as shown in FIG. 5 with connectors 432, for example, swagelock connections with graphite ferrules. The support may be heated up to 600° C. at 1° C./min, for example, with two Ar flows through the tube side 404 and shell side 406, respectively. CVD reactor assembly 402 as shown includes an entering balance Ar gas stream 422 and exiting Ar balance stream 424. Materials of construction 426 for CVD reactor assembly include ¼ inch stainless steel or quartz tubing, for example.

The deposition of silica can begin after a carrier Ar gas flows through a bubbler filled with TEOS in membrane synthesis system 412 and carries the TEOS vapor into the channels of the support 408. The linear flow rate in the channels of the support can be in the range of, for example, 1-10 cm/s. The TEOS concentration can be in the range of, for example, 0.02-0.50 mol %. Ar gas may first be purified by purifiers 418 before use. Flow rates of the Ar gas may be controlled by mass flow controllers 420. CVD apparatus 400 as shown also includes vent 428 and back-pressure regulator 430.

After a period of deposition, the deposition process can be stopped and the gas separation performance through the as-deposited silica layer can be evaluated by a screen-testing system 410. The test can be conducted by introducing different individual gases, such as H₂, He, N₂, or CO₂ into the membrane channels and measuring the permeation flux for different gases. The screen-testing system 410 as shown includes pressure regulator 414 and soap flow meter 416. If the performance is not satisfactory, the deposition process can continue.

In another embodiment, the amorphous silica membrane can be applied onto the inner channel surfaces of the inorganic porous support or onto the surface of the one or more porous intermediate layers using a sol-gel method. In one embodiment, TEOS may be used as a silica precursor to prepare a silica sol, the sol is applied onto the inner channel surfaces of the inorganic porous support or onto the surface of the one or more porous intermediate layers, and the resulting structure can be dried and fired.

Suitable thicknesses and other suitable characteristics of the amorphous silica membrane are also discussed hereinabove and shall not be repeated here.

The present invention provides a process route for silica membrane synthesis that is feasible for large-scale production. The CVD method has been widely used for semiconductor industry. Moreover, the CVD method in this invention does not require an expensive vacuum system. Meanwhile, the deposition process happens in a closed environment and thus defect-controlling is much easier compared to other processes in an open environment such as sol-gel.

Hybrid membrane structures of the present invention and hybrid membrane structures made in accordance with the methods of the present invention can be used in a variety of applications, such as in methods for H₂ separation/purification, including separation of H₂ from CO₂. For example, the invention includes a method for purifying H₂, which comprises:
introducing a feed gas stream comprising H₂ into the first end of a hybrid membrane structure of the invention; and
collecting a permeate gas stream from the hybrid membrane structure that is higher in H₂ content than the feed gas.

The feed gas in this embodiment may also comprise CO₂, for example. In this context, the method of the invention could involve the separation of H₂ from CO₂, with the retentate gas stream being higher in CO₂ content than the feed gas.

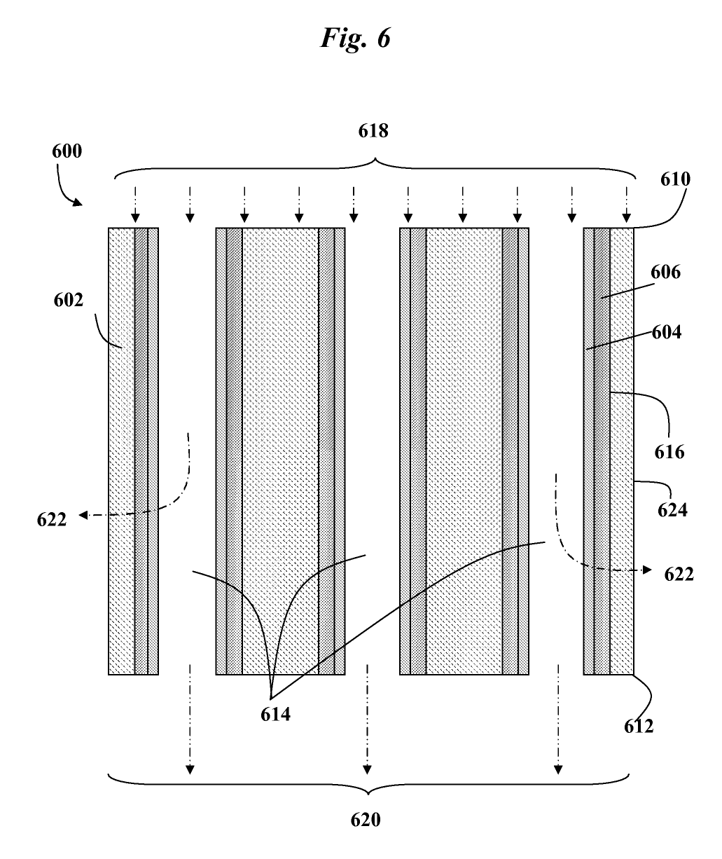

An example process is illustrated in FIG. 6. Feed gas 618 (in this instance comprising both hydrogen and carbon dioxide) is introduced into first end 610 of hybrid membrane structure 600 and passes into channels 614. Some of the hydrogen molecules in feed gas 618 permeate through amorphous silica membrane 604 and intermediate layer 606 disposed on surface 616, of inorganic porous support 602, and, after passing through the pores of inorganic porous support 602, emanate from the hybrid membrane structure's outer surface 624. The path of such hydrogen molecules is represented by arrows 622. The remainder of feed gas 618, including carbon dioxide, remains in channels 614 and is permitted to exit second end 612 of hybrid membrane structure 600 as retentate gas stream 620. Retentate gas stream 620 that is collected from second end 612 of hybrid membrane structure 600 is higher in carbon dioxide content and lower in hydrogen content than feed gas 618. Permeate gas 620 that is collected is higher in hydrogen content and lower in carbon dioxide content than feed gas 618. Depending on the application and the nature of the feed gas involved, the collected gases can be stored, used as a feed gas in a further process, or discharged to the atmosphere.

The particular example described above included both carbon dioxide and hydrogen in the feed gas. It will be appreciated that a feed gas may comprise, for example, hydrogen but not carbon dioxide, and that the feed gas may comprise one or more other gases, such as water vapor, carbon monoxide, nitrogen, hydrocarbons, and combinations thereof, and that the invention may comprise separation of one or more of the components of the feed gas components. It will also be appreciated that the hybrid membrane structure of the invention may be used to separate one or more of such components from a feed gas stream, in addition to or as an alternative to separating hydrogen and/or carbon dioxide.

The present invention is further illustrated by the following non-limiting examples.

### EXAMPLE 1

### Preparation of boehmite sol

In this example, a stable colloidal boehmite (AlOOH) sol is prepared with the use of aluminum tri-sec-butoxide and nitric acid as the alumina precursor and peptization agent.

600 ml of D.I. water was heated up to above 80° C. and a quantity of 98.53 g of aluminum tri-sec-butoxide (Aldrich) was then added. The mixture was stirred at a high speed and was maintained at 80-85° C. for 24 h, allowing hydrolysis of the aluminum alkoxide, forming a white precipitate. The precipitate was then heated to above 90° C. and the container was opened for evaporation of as-produced alcohol. After 1-2 h of evaporation, the container was closed and the temperature was kept at around 92° C. with refluxing. After 1 h of stabilization, the precipitate was peptized with 4.918 g of concentrated nitric acid (68-70%, TME™). The molar ratio of H⁺/Al=0.13. The solution was kept at 90-95° C. with refluxing for 20 hours to get a stable and clear sol.

The concentration of the original sol obtained was in the range of 0.75-1.0 M, and the exact sol concentration was obtained by measuring the volume of the sol. A dynamic light scattering analyzer (Microtrac, Microtrac Inc.) was used to measure the particle size distribution of the sol. The obtained original sol has a narrow particle size distribution with a median particle size of 60-120 nm.

### EXAMPLE 2

### Preparation of Gamma-Alumina Intermediate Layer on Modified Monolith Supports

This example illustrates the making of a uniform and crack-free gamma-alumina intermediate layer with a pore size of about 5 nm on the inner channel surface of a modified monolith support (i.e., a support with intermediate layers applied). The solutions include (i) multiple coatings with dilute coating solutions; (ii) first coating with higher concentration coating solution and subsequent coating with lower concentration solution; (iii) changing flow direction of coating solution going through the channels between two coatings; and (iv) controlling the pH value of coating solution.

Two coating solutions with the sol concentration of 0.6 and 0.2 M were prepared with the use of the original boehmite sol as described in Example 1. 76.5 g of 0.94 M original sol was mixed with 42 g of 4.0 wt. % PVA solution and 1.5 g of D.I. water. After stirring at 50-60° C. for 2 h, a coating solution with the sol concentration of 0.6 M was made, and pH value was adjusted to be in the range of 3.2-3.8 by using IM nitric acid solution. The 0.2 M coating solution was made using the same technique.

The support used in this example was a 19-channel alpha-alumina tube with inner channels already modified with multilayers of alpha-alumina membranes of pore size of 100-200 nm as intermediate layers. A flow-coater was used to deposit the boehmite sol layer on the inner channel surface of the monolith support. The 6″ long monolith substrate of pore size of around 100 nm was mounted into the flow coater, and then the 0.6 M coating solution was sucked into the channels of the substrate by a pressure differential. The soaking time was 20 seconds. The coated support was spun for 60 sec at a speed of 725 rpm to remove excess coating solution in the channels, dried at 120° C. for 2 h, and fired at 650° C. for 2 h at a heating rate of 1° C./min. The same procedure was repeated with the use of 0.2 M coating solution, and a third coating could be applied with use of the same coating solution.

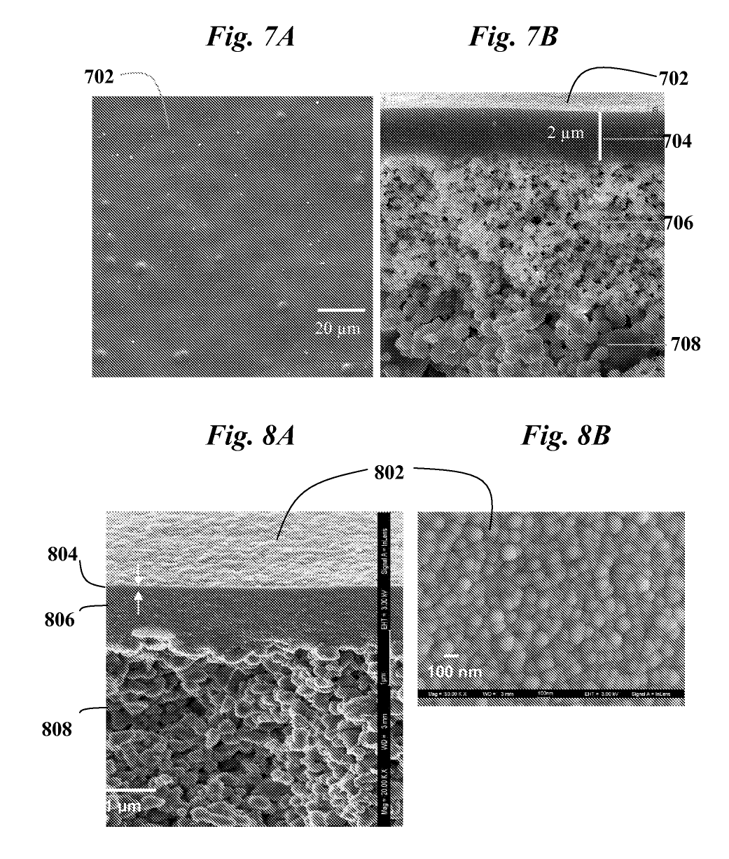

FIG. 7A shows an SEM image of the channel surface 702 of the gamma-alumina coating. FIG. 7B shows an SEM image of the cross-section of the gamma-alumina intermediate layer 704, and underlying alpha-alumina intermediate layer 706 having a median pore size of 100 nm, and alpha-alumina intermediate layer 708 having a median pore size of 400 nm. The surface of the gamma-alumina intermediate layer was smooth and no cracks were found. The thickness of the gamma-alumina layer was about 2 um.

### EXAMPLE 3

### Preparation of an Amorphous Silica Membrane on a Modified Monolith Support

This example illustrates deposition of a uniform silica membrane along the axial direction by a non-pressurized CVD process on a 6″ long modified monolith support with an intermediate layer of pore size of 5 nm made in Example 2. In this example, a high carrier Ar gas linear flow rate of 8 cm/s and a low TEOS concentration of 0.05 mol % were used.

A CVD apparatus illustrated in FIG. 4 was used to deposit a silica layer on the inner channel surface of 5 nm-pore substrates via thermal decomposition of tetraethoxysilane (TEOS) at high temperature in an inert environment. First, the substrate was put into a CVD reactor assembly (FIG. 5) and was heated up to 600° C. at 1° C./min with Ar flowing through both tube side and shell side. Secondly, the silica deposition started when a carrier Ar gas with a flow rate of 12 sccm flowed through a bubbler filled with TEOS and carried the TEOS vapor (22° C.) into the channels of the substrate, after mixing with a dilute Ar flow at 34 sccm. Meanwhile, a balance Ar gas at a flow rate of 46 sccm was introduced to the shell side of the assembly. The carrier gas linear flow rate was 8.0 cm/s and the TEOS concentration 0.05 mol %. After 7.5 h of deposition, the carrier gas flow was stopped, and other two Ar streams (dilute and balance) kept flowing for purging purpose. After for around 20 min, these two streams were closed. The gas separation performance through the as-deposited silica layer was then evaluated by introducing individual gases (H₂, He, CO₂, N₂, etc.) into the channels and measuring the flow rate of the gas permeating through the membrane. After measurement, the CVD process was resumed for another 12 h and the as-deposited silica membrane was evaluated again. The CVD process can be stopped at any point, for example, at a satisfactory selectivity.

Table 1 lists changes of single gas permeance and ideal selectivity at 600° C. of the monolith silica membrane as a function of deposition time.

TABLE 1

| | | Deposition time, hr | | | |
|---|---|---|---|---|---|
| | | 0 | 7.5 | 29.5 | 32.8 |
| Permeance, | H2 | 224 | 131 | 7.34 | 5.42 |
| sccm/cm²/bar | He | 158 | | 7.94 | 7.72 |
| | N2 | 71.3 | 40.3 | 1.43 | 1.58 |
| | CO2 | 55.3 | 27.9 | 1.30 | 1.15 |
| Ideal selectivity | H2/N2 | 3.14 | 3.26 | 5.13 | 3.43 |
| | H2/CO2 | 4.04 | 4.70 | 5.63 | 4.71 |
| | He/N2 | 2.22 | | 5.54 | 4.89 |
| | He/CO2 | 2.85 | | 6.09 | 6.72 |

Before CVD, the permeance through the monolith gamma-alumina support at 600° C. was very high and follows the order of molecular weight, which is H₂>He>N₂>CO₂. The lighter the molecule, the higher the permeance. This is because that the gas transport mechanism through a 5 nm-pore gamma-alumina membrane is dominated by Knudsen diffusion. The selectivities of H₂/CO₂ and He/CO₂ were 4.0 and 2.9, respectively, which are close to the value expected by Knudsen diffusion (4.7 and 3.3). With the silica deposition processing, the permeance for all gases decreased but decreased faster for N₂ and CO₂, thus leading to the increase of H₂ or He selectivity over N₂ or CO₂. After 29.5 h of deposition, the selectivities of H₂/CO₂ and He/CO₂ were 5.6 and 6.1, which are higher than the Knudsen value. He permeance was higher than H₂ permeance. This indicates of formation of molecule-sieving silica membrane, as an He molecule is smaller that H₂ molecule.

FIG. 8A shows an SEM image of the cross section of the silica membrane 804 (assisted with two arrows identifying the cross-section), as well as the cross section of the gamma alumina intermediate layer 806 and underlying intermediate layer of alpha-alumina 808 having a median pore size of 100 nm. FIG. 8B shows an SEM image of the top surface of the silica membrane 802. It is clear that a continuous silica layer with a thickness of 100 nm was deposited on the gamma-alumina layer. The different contrast between silica layer and gamma-alumina layer indicates that the silica structure is denser.

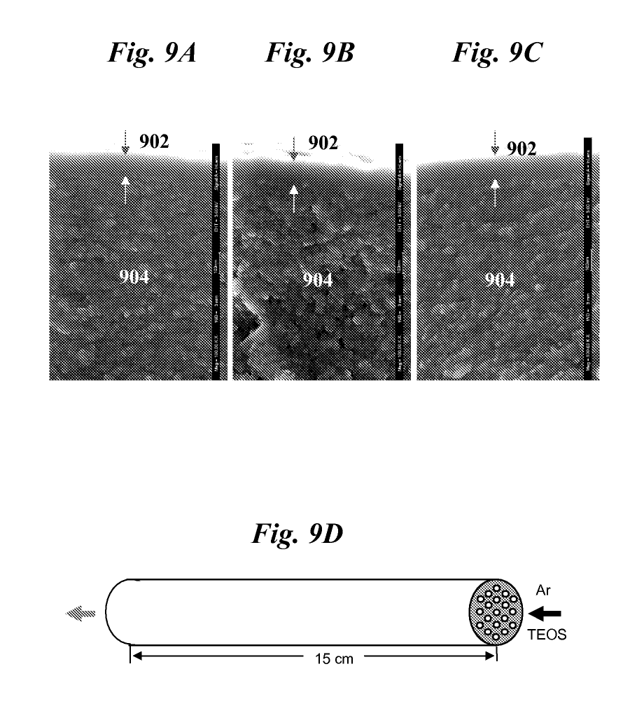

FIGS. 9A-9C compare the cross-sectional view of the silica membrane 902 deposited on different positions of the monolith on the gamma-alumina intermediate layer 904 (FIG. 9A at the end; FIG. 9B at the middle; FIG. 9C and the beginning) along the tube axial direction from the beginning to the end (based on flow direction illustrated in FIG. 9D). It clearly demonstrates that the silica layer was quite uniform along the axial direction. Advantageously, in some embodiments of the invention, the silica membrane can be provided with a substantially uniform thickness among channels across the cross-section of the support or modified support. For example, with reference to FIG. 9D, an embodiment of the invention includes depositing the silica membrane having a thickness in an inner-most channel that is substantially the same thickness as the membrane in an outermost channel of the support. This can be achieved, for example, using the CVD method for applying the amorphous silica membrane as described herein.

### EXAMPLE 4

### Preparation of an Amorphous Silica Membrane on a Modified Monolith Support

In this example a pressurized CVD process is described to make another monolith silica membrane with better selectivity on a 3″ long gamma-alumina monolith substrate with a pore size of 5 nm as made in Example 2. In this comparative test, the same batch of gamma-alumina monolith substrate was used for deposition of silica membrane by using the non-pressurized process described in Example 3.

The same CVD apparatus as in Example 3 was used. Also the same deposition process was applies except for keeping a high pressure (higher than ambient pressure) on the tube side by adjusting the back-pressure regulator in the gas exit line (see FIG. 4) (e.g. restricting the outlet flow). As a result, a certain pressure difference was applied on the membrane substrate through the CVD deposition process. The pressure difference can be in the range of 0.1-15 psi. In this example, a pressure difference of 0.6 psi was used. The CVD deposition was conducted at 600° C. with a carrier Ar linear flow rate of 8.0 cm/s and a TEOS concentration of 0.05 mol %. The single gas permeance data was collected during the deposition process. After 67.5 h-deposition, the selectivities of He/CO₂ and H₂/CO₂ reached up to 8.5 and 6.2, respectively.

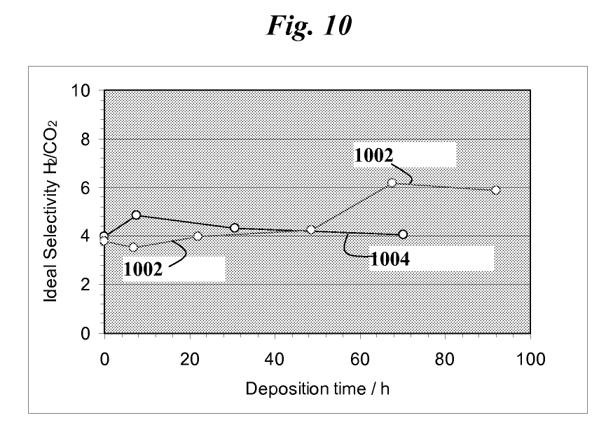

FIG. 10 compares ideal selectivity of H₂/CO₂ of the silica membranes prepared by the pressurized CVD process 1002 and the non-pressurized CVD process 1004. The same deposition temperature, carrier Ar linear flow rate and TEOS concentration were used in non-pressurized CVD process. After around 50 h of deposition with the pressurization, the H₂/CO₂ selectivity increased from 4 to 6, while the selectivity remained unchanged without pressurization. After deposition of similar long period (67.5 vs. 70.3 h), with the use of pressurization, the selectivities of H₂/CO₂ and He/CO₂ improved from 4.1 to 6.2 and 4.0 to 8.5, respectively. The improvement was likely due to quick silica growth, especially around some defects on the substrate by pressurization on the substrate. The SEM analysis indicated that the silica deposition rate was 2.2 nm/h, compared to 0.9 nm/h for the non-pressurized deposition process.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention, as defined in the claims which follow.

We claim:

1. A hybrid membrane structure comprising:
a monolithic inorganic porous support comprising a first end, a second end, and a plurality of inner channels having surfaces defined by porous walls and extending through the support from the first end to the second end;
optionally, one or more porous inorganic intermediate layers coating the inner channel surfaces of the inorganic porous support; and
an amorphous silica membrane; wherein, when the hybrid membrane structure does not comprise the one or more porous inorganic intermediate layers, the amorphous silica membrane coats the inner channel surfaces of the inorganic porous support; and wherein, when the hybrid membrane structure comprises the one or more porous inorganic intermediate layers, the amorphous silica membrane coats the surface of the one or more porous intermediate layers.

2. A hybrid membrane structure according to claim 1, wherein the inorganic porous support is a honeycomb monolith.

3. A hybrid membrane structure according to claim 1, wherein the inorganic porous support is a ceramic monolith.

4. A hybrid membrane structure according to claim 1, wherein the inorganic porous support comprises cordierite, alpha-alumina, delta-alumina, gamma-alumina, carbon, mullite, aluminum titanate, titania, zirconia, zeolite, metal, silica carbide, ceria, or combinations thereof.

5. A hybrid membrane structure according to claim 1, wherein the inner channels of the inorganic porous support have a hydraulic inside diameter of 3 millimeters or less.

6. A hybrid membrane structure according to claim 1, wherein the inorganic porous support has a porosity of from 35 percent to 50 percent.

7. A hybrid membrane structure according to claim 1, wherein the hybrid membrane structure does not comprise the one or more porous inorganic intermediate layers, wherein the inner channel surfaces of the inorganic porous support comprise a median pore size of 1 micron or less, and wherein the amorphous silica membrane coats the inner channel surfaces of the inorganic porous support.

8. A hybrid membrane structure according to claim 1, wherein the hybrid membrane structure comprises the one or more porous inorganic intermediate layers and wherein the amorphous silica membrane coats the surface of the one or more porous intermediate layers.

9. A hybrid membrane structure according to claim 8, wherein the porous walls of the inorganic porous support comprise a median pore size of from 5 microns to 15 microns.

10. A hybrid membrane structure according to claim 8, wherein the one or more porous intermediate layers comprise alpha-alumina, delta-alumina, gamma-alumina, titania, zirconia, silica, cordierite, mullite, aluminum titanate, zeolite, metal, silica carbide, ceria, or combinations thereof.

11. A hybrid membrane structure according to claim 8, wherein the hybrid membrane structure comprises one intermediate layer.

12. A hybrid membrane structure according to claim 11, wherein the intermediate layer comprises a median pore size of from 20 nanometers to 1 micron.

13. A hybrid membrane structure according to claim 12, wherein the intermediate layer comprises alpha-alumina.

14. A hybrid membrane structure according to claim 1, wherein the hybrid membrane structure comprises at least two intermediate layers.

15. A hybrid membrane structure according to claim 14, wherein the first intermediate layer closest to the inorganic porous support comprises a median pore size of from 20 nanometers to 1 micron and the intermediate layer closest to the amorphous silica membrane comprises a median pore size of 10 nanometers or less.

16. A hybrid membrane structure according to claim 14, wherein the first intermediate layer comprises alpha-alumina and the second intermediate layer comprises gamma-alumina.

17. A hybrid membrane structure according to claim 8, wherein the one or more porous intermediate layers have a combined thickness of from 20 nanometers to 100 microns.

18. A hybrid membrane structure according to claim 1, wherein the amorphous silica membrane has a thickness of from 20 nanometers to 2 microns.

19. A method for purifying H₂ in a gas stream, said method comprising:
introducing a feed gas stream comprising H₂ into the first end of a hybrid membrane structure according to claim 1; and
collecting a permeate gas stream from the hybrid membrane structure that is higher in H₂ content than the feed gas.

20. A method for making a hybrid membrane structure, said method comprising:
providing a monolithic inorganic porous support comprising a first end, a second end, and a plurality of inner channels having surfaces defined by porous walls and extending through the support from the first end to the second end;
optionally applying one or more porous inorganic intermediate layers to the inner channel surfaces of the inorganic porous support; and
applying an amorphous silica membrane; wherein, when the one or more porous inorganic intermediate layers have not been applied to the inorganic porous support's inner channel surfaces, the amorphous silica membrane is applied to the inner channel surfaces of the inorganic porous support; and wherein, when the one or more porous inorganic intermediate layers have been applied to the inorganic porous support's inner channel surfaces, the amorphous silica membrane is applied to the surface of the one or more porous intermediate layers.

21. A method according to claim 20, which comprises applying at least one porous inorganic intermediate layer to the inner channel surfaces of the inorganic porous support, wherein the at least one porous inorganic intermediate layer comprises alpha-alumina.

22. A method according to claim 20, which comprises applying at least two porous inorganic intermediate layers to the inner channel surfaces of the inorganic porous support, wherein the first inorganic intermediate layer closer to the inorganic porous support comprises alpha-alumina and a second inorganic intermediate layer closer to the amorphous silica membrane comprises gamma-alumina.

23. A method according to claim 22, which comprises applying the second inorganic intermediate layer comprising gamma alumina by applying a colloidal boehmite sol precursor, and drying and firing the precursor to form gamma alumina.

24. A method according to claim 20, which comprises applying the amorphous silica membrane by chemical vapor deposition.
